(19) United States
(12) Patent Application Publication
(10) Pub. No.: US 2010/0172284 A1
(43) Pub. Date: Jul. 8, 2010

(54) Mobile Communication System, Radio Communication Relay Station Device, and Relay Transmission Method

(75) Inventors: Ayako Horiuchi, Kanagawa (JP); Kenichi Miyoshi, Kanagawa (JP)

Correspondence Address: Dickinson Wright PLLC;James E. Ledbetter, Esq., International Square, 1875 Eye Street, N.W., Suite 1200, Washington, DC, 20006, US

(73) Assignee: PANASONIC CORPORATION, Osaka (JP)

(21) Appl. No.: 12/601,203

(22) PCT Filed: May 21, 2008
(86) PCT No.: PCT/JP2008/001267

§ 371 Date: Nov. 20, 2009

(30) Foreign Application Priority Data
May 22, 2007 (JP) 2007-135578

(51) Int. Cl. H04W 72/04; H04B 7/14

(52) U.S. Cl. 370/315; 370/329

(57) ABSTRACT

Provided is a radio communication relay station device which can improve a line quality measurement accuracy. In the radio communication relation station (100), when a frequency band exchange instruction signal is not inputted from a radio reception unit (102), a frequency band allocation unit (109) allocates F2 to transmission of a downstream line signal and a radio transmission unit (110) relays and transmits the downstream line signal by using the F2. On the other hand, when the frequency band exchange instruction signal is inputted from the radio reception unit (102), the frequency band allocation unit (109) allocates the F2 to transmission of an upstream line signal and the radio transmission unit (110) relays and transmits the upstream line signal by using the F2.

### TECHNICAL FIELD

The present invention relates to a mobile communication system, radio communication relay station apparatus and relay transmission method.

### BACKGROUND ART

In recent years, with the multimediatization of information in cellular mobile communication systems, transmitting high capacity data such as still image data and moving image data in addition to speech data, has become popular. To realize the transmission of high capacity data, the technique for realizing a high transmission rate utilizing a high-frequency radio band is studied actively.

However, when a high-frequency radio band is used, although a high transmission rate is expected in a short distance, attenuation due to a transmission distance becomes greater when the distance increases. Accordingly, when a mobile communication system employing a high-frequency radio band is actually operated, the coverage area of a radio communication base station apparatus (hereinafter abbreviated to “base station”) becomes small, and, consequently, a larger number of base stations need to be set up. The setup of base stations requires an expensive cost, and therefore there is a strong demand for a technique for preventing an increased number of base stations and realizing communication services utilizing a high-frequency radio band.

To meet this demand, techniques are studied in which radio communication relay station apparatuses (hereinafter abbreviated to “relay stations”) are set up between a base station and a radio communication mobile station apparatus (hereinafter abbreviated to “mobile station”), and communication between the base station and the mobile station is performed via these relay stations to expand the coverage area of each base station.

Methods of selecting a relay station in relay transmission techniques include measuring channel quality between a base station and relay stations, measuring channel quality between the relay stations and a mobile station, and selecting relay stations of higher channel quality (see Patent Document 1).

Also, channel allocation methods of a relay station in relay transmission techniques include measuring channel quality between a base station and relay stations, measuring channel quality with respect to a plurality of channels between the relay stations and a mobile station, and preferentially allocating relay signals to channels of higher channel quality.

### Patent Document 1: Japanese Patent Application Laid-Open No. 2004-254308

### Patent Document 2: Japanese Patent Application Laid-Open No. 2006-050545

### DISCLOSURE OF INVENTION

### Problems to be Solved by the Invention

As described in the above prior art, if a relay transmission technique is applied to mobile communication, there are normally a plurality of relay stations for one base station. Accordingly, the number of channels that can be allocated to downlink signals on a per mobile station basis, is smaller when a relay transmission technique is applied to mobile communication than when the relay transmission technique is not applied to mobile communication. Therefore, if a relay transmission technique is applied to mobile communication, a mobile station has a decreased number of channels in which a channel quality measurement is possible, and, consequently, the accuracy of channel quality measurement becomes poor in the whole frequency band in which the mobile station can perform reception.

It is therefore an object of the present invention to provide a mobile communication system, relay station and relay transmission method that can improve the accuracy of channel quality measurement.

### Means for Solving the Problem

The mobile communication system of the present invention employs a configuration having a radio communication base station apparatus, a radio communication mobile station apparatus and a radio communication relay station apparatus that performs relay transmission between the radio communication base station apparatus and the radio communication mobile station apparatus, in which: using a first frequency band, the radio communication relay station apparatus transmits a downlink signal in a first frame and transmits an uplink signal in a second frame; and, using the first frequency band, the radio communication mobile station apparatus receives the downlink signal in the first frame and receives the uplink signal in the second frame.

### ADVANTAGEOUS EFFECT OF INVENTION

According to the present invention, it is possible to improve the accuracy of channel quality measurement.

### BRIEF DESCRIPTION OF DRAWINGS

FIG. 1 illustrates the configuration of a mobile communication system according to embodiments of the present invention;

FIG. 2 illustrates frequency band allocation according to Embodiment 1 of the present invention;

FIG. 3 is a sequence diagram according to Embodiment 1 of the present invention;

FIG. 4 is a block diagram showing the configuration of a relay station according to Embodiment 1 of the present invention;

FIG. 5 is a flowchart showing the operations of a relay station according to Embodiment 1 of the present invention;

FIG. 6 is a block diagram showing the configuration of a base station according to Embodiment 1 of the present invention;

FIG. 7 illustrates frequency band allocation according to Embodiment 2 of the present invention;

FIG. 8 is a sequence diagram according to Embodiment 2 of the present invention;

FIG. 9 is a block diagram showing the configuration of a relay station according to Embodiment 2 of the present invention;

FIG. 10A illustrates a received signal and known signal of a mobile station according to Embodiment 2 of the present invention (frame 1);

FIG. 10B illustrates a received signal and known signal of a mobile station according to Embodiment 2 of the present invention (frame 2);

FIG. 11 illustrates the configuration of a mobile communication system according to Embodiment 3 of the present invention;

FIG. 12 is a block diagram showing the configuration of a base station according to Embodiment 3 of the present invention;

FIG. 13A illustrates serving relay station information according to Embodiment 4 of the present invention; and

FIG. 13B illustrates channel allocation information according to Embodiment 4 of the present invention.

### BEST MODE FOR CARRYING OUT THE INVENTION

Embodiments of the present invention will be explained below in detail with reference to the accompanying drawings.

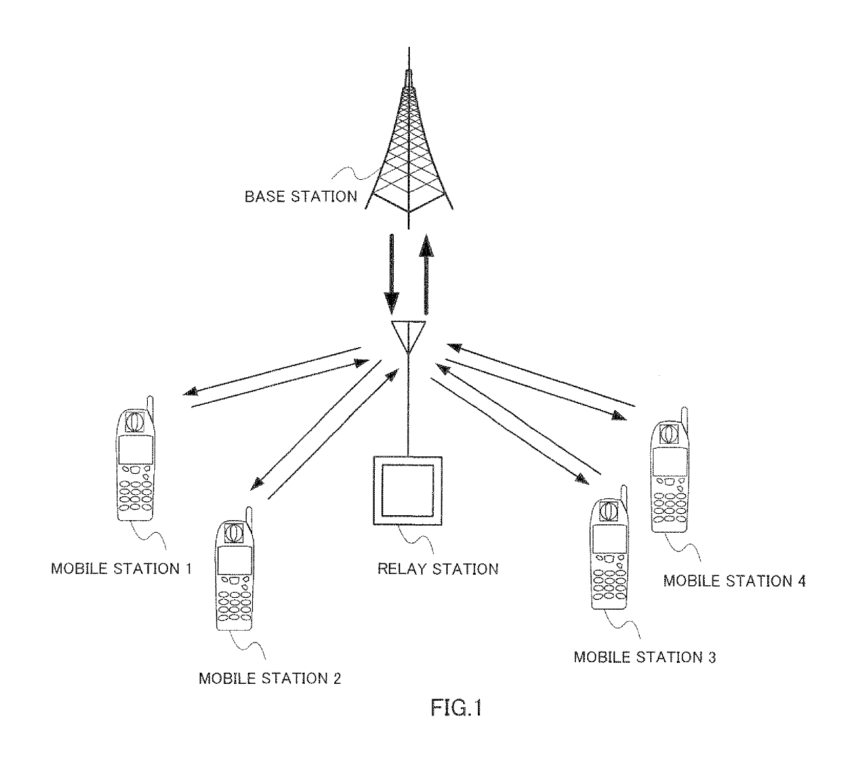

FIG. 1 illustrates the configuration of a mobile communication system according to embodiments of the present invention. As shown in FIG. 1, in a mobile communication system according to the following embodiments, a relay station relays uplink signals from mobile stations 1 to 4 to a base station in uplink, and relays downlink signals from the base station to mobile stations 1 to 4 in downlink. Also, the mobile communication system according to the following embodiments adopts a FDD (Frequency Division Duplex) scheme, and distinguishes uplink from downlink using frequency band F1 and frequency band F2. Also, the mobile communication system according to the following embodiments uses a plurality of subcarriers as a plurality of channels, and forms F1 and F2, each with a plurality of subcarriers, that is, each with a plurality of channels. Also, in the mobile communication system according to the following embodiments, an uplink signal and a downlink signal include a pilot signal.

Also, the relay station according to the following embodiments may be a fixed relay station that is set up in advance or a mobile station that is used as a relay station like in an ad hoc network (e.g. see Japanese Patent Application Publication No. 2001-189971).

### Embodiment 1

With the present embodiment, a relay station uses F2 to transmit a downlink signal in frame 1 and an uplink signal in frame 2, and a mobile station uses F2 to receive the downlink signal in frame 1 and the uplink signal in frame 2.

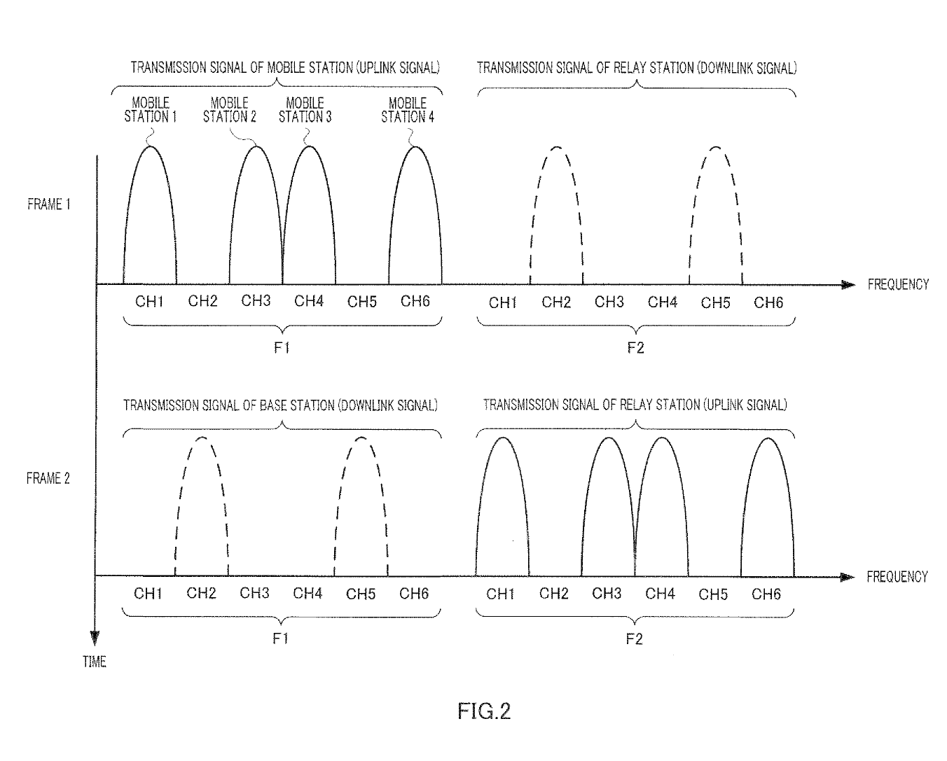

FIG. 2 illustrates the frequency band allocation according to the present embodiment. Here, mobile stations 1 to 4, the relay station and the base station shown in FIG. 1 measure channel quality from the pilot signals included in the signals received using F1 and F2, and generate CQI's (Channel Quality Indicators). Also, the CQI information generated in mobile stations 1 to 4 and the relay station, is reported to the base station.

First, in frame 1, each mobile station uses F1 to transmit an uplink signal. To be more specific, mobile station 1 transmits an uplink signal using CH 1 among CH's (CHannels) 1 to 6 forming F1. Similarly, mobile station 2 transmits an uplink signal using CH 3 in F1, mobile station 3 transmits an uplink signal using CH 4 in F1, and mobile station 4 transmits an uplink signal using CH 6 in F. That is, in frame 1, the relay station receives uplink signals using CH 1, CH 3, CH 4 and CH 6 in F1.

Also, in frame 1, the relay station uses F2 to transmit the downlink signals received in the frame previous to frame 1. To be more specific, as shown in FIG. 2, the relay station transmits downlink signals using CH 2 and CH 5 among CH 1 to CH 6 forming F2. For example, the downlink signal that is allocated to CH 2 in F2 is directed to mobile station 1, and the downlink signal that is allocated to CH 5 in F2 is directed to mobile station 2. Therefore, in frame 1, mobile station 1 receives a downlink signal using CH 2 in F2, and mobile station 2 receives a downlink signal using CH 5 in F2.

Here, in F2 of frame 1 shown in FIG. 2, for the transmission of downlink signals, the relay station shares CH 1 to CH 6 with the base station and other relay stations (not shown). Therefore, each relay station has a decreased number of channels to which downlink signals can be allocated. That is, each mobile station has a decreased number of channels that can be used in channel quality measurement between the relay station and each mobile station. On the other hand, in F1 of frame 1 shown in FIG. 2, the relay station groups a plurality of uplink signals from a plurality of mobile stations, and therefore requires many channels.

Therefore, with the present embodiment, the relay station allocates F2, which is allocated to transmit downlink signals in frame 1, for the transmission of uplink signals in frame 2. Also, the mobile stations receive uplink signals that are transmitted by the relay station using F2. Also, the relay station allocates F1, which is allocated to receive uplink signals in frame 1, for the reception of downlink signals in frame 2. Also, in frame 1, the relay station allocates F1 to receive uplink signals and to transmit the uplink signals received in the frame previous to frame 1, and allocates F2 to transmit the downlink signals received in the frame previous to frame 1 and to receive downlink signals. That is, the relay station and the base station temporarily use F1, which is used for uplink signals in frame 1, for downlink signals in frame 2, and temporarily use F2, which is used for downlink signals in frame 1, for uplink signals in frame 2. That is, the relay station and the base station exchange the frequency band used for uplink signals and the frequency band used for downlink signals, between frame 1 and frame 2.

Also, in frame 2, the mobile stations do not transmit uplink signals using F1. This is because, if the mobile stations transmit uplink signals using F1, the base station has difficulty separating transmission of downlink signals from reception of uplink signals in F1 of frame 2. That is, in frame 2, communication is performed only between the base station and the relay station. Here, the mobile stations can receive signals using F2 even in frame 2. Also, with the present embodiment, upon performing the above frequency band exchanging, the base station transmits a frequency band exchange command signal indicating a exchange of frequency bands, to the relay station. That is, in frame 1, the base station transmits a frequency band exchange command signal to the relay station using F2.

Therefore, as shown in FIG. 2, the relay station transmits the uplink signals, which are received in frame 1 using F1, temporarily using F2 in frame 2. To be more specific, in frame 2, the relay station relays uplink signals using CH 1, CH 3, CH 4 and CH 6 among CH 1 to CH 6 forming F2. That is, the transmission signal of each mobile station is transmitted using F1 from each mobile station to the relay station, and transmitted using F2 from the relay station to the base station. Also, the base station transmits downlink signals using CH 2 and CH 5 temporarily in F1 of frame 2.

Thus, the relay station temporarily uses F2, which is used to transmit downlink signals in frame 1, for the transmission of uplink signals in frame 2, so that the mobile stations can receive the signals that are transmitted from the relay station using F2 in frame 1 and frame 2. By this means, the mobile stations have an increased number of channels that can be used in channel quality measurement between the relay station and the mobile stations. To be more specific, while the mobile stations can measure channel quality of only two channels of CH 2 and CH 5 in F2 of frame 1, the mobile stations can measure channel quality of four channels of CH 1, CH 3, CH 4 and CH 6 in F2 of frame 2. That is, the mobile stations can measure channel quality of all channels of CH 1 to CH 6 forming F2. Thus, in the mobile stations, channel quality measurement is possible in more channels than in the prior art, using only F2 in which the mobile stations can perform reception.

Also, the mobile stations can measure channel quality even when the relay station transmits uplink signals in frame 2, in addition to when the mobile stations receive downlink signals in frame 1, so that channel quality measurement is possible in more channels with a shorter time than in the prior art.

Also, the relay station transmits uplink signals using F1 in frame 1. Here, CH 1 to CH 6 forming F1 are shared and used by a plurality of relay stations, and, consequently, each relay station has a decreased number of channels in which channel quality measurement is possible in the base station. On the other hand, each relay station can receive signals both in F1 and F2. Therefore, as shown in frame 2 in FIG. 2, the base station transmits downlink signals using F1 temporarily, so that each relay station, including the relay station shown in FIG. 1, can receive downlink signals even in F1 and measure channel quality between the subject relay station and the base station, using even downlink signals not addressed to the subject relay station. Therefore, by transmitting downlink signals using F1 temporarily in the base station, channel quality measurement is possible in more channels between the relay station and the base station than in the prior art.

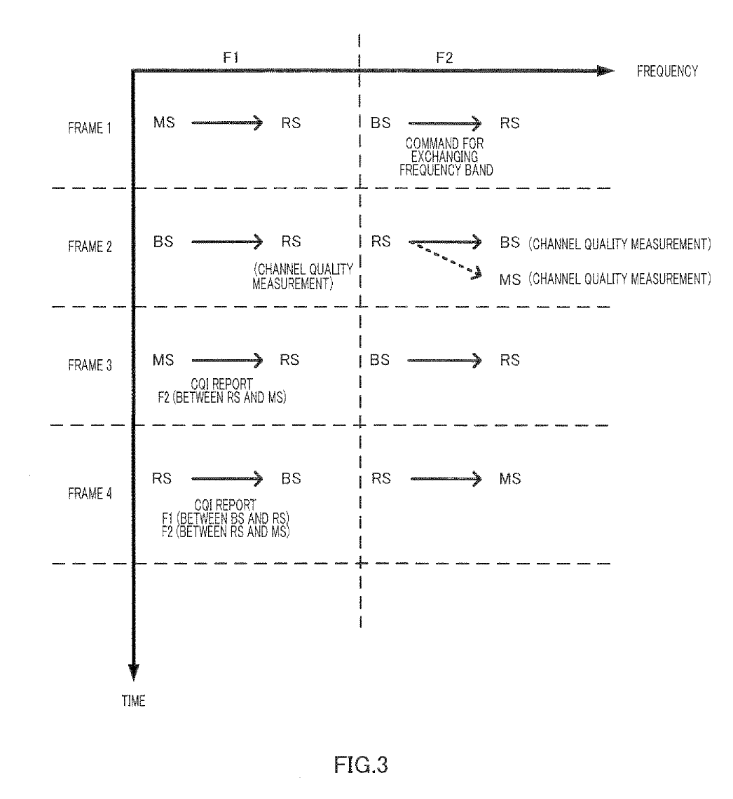

Next, FIG. 3 illustrates a sequence diagram of the mobile communication system according to the present embodiment. In FIG. 3, a relay station (“RS”) performs relay transmission between a base station (“BS”) and a mobile station (“MS”). In this case, there is also an MS (not shown) that performs direct communication with a BS without involving an RS, and the BS measures channel quality between the BS and the MS. Here, for ease of explanation, explanation of an MS that performs direct communication with a BS without involving an RS, will be omitted.

As shown in FIG. 3, first, an MS transmits an uplink signal to an RS in F1 of frame 1. Also, in F2 of frame 1, a BS transmits a frequency band exchange command signal to the RS. Therefore, in the BS and the RS, when the target frame shifts from frame 1 to frame 2, the frequency band used for uplink signals and the frequency band used for downlink signals are temporarily exchanged between F1 and F2.

Next, in F1 of frame 2, the BS transmits a downlink signal to the RS. Also, in F2 of frame 2, the RS relays the uplink signal received from the MS in frame 1, to the BS. Also, in frame 2, the BS measures channel quality between the BS and the RS using the uplink signal received in F2, and the RS measures channel quality between the BS and the RS using the downlink signal received in F1. Also, the MS can receive the uplink signal relayed by the RS, and therefore receives the uplink signal in F2 of frame 2 and measures channel quality between the RS and the MS.

Next, when the target frame shifts from frame 2 to frame 3, the frequency bands, which were temporarily exchanged when the target frame shifted from frame 1 to frame 2, are restored to the original. Also, in F1 of frame 3, the MS transmits an uplink signal to the RS. In this case, the MS reports a CQI indicating channel quality (i.e., channel quality between the RS and the MS in F2) measured in frame 2, to the RS. Also, in F2 of frame 3, the BS transmits a downlink signal to the RS.

Next, in F1 of frame 4, the RS relays the uplink signal received from the MS in frame 3, to the BS. In this case, the RS reports a CQI indicating channel quality (i.e. channel quality between the BS and the RS in F1) measured in frame 2, and the CQI reported from the MS in frame 3, to the BS. Also, in F2 of frame 4, the RS relays the downlink signal received from the BS in frame 3, to the MS.

Next, the base station performs a new channel allocation based on the CQI's reported in frame 4, a CQI indicating channel quality (i.e. channel quality between the BS and the RS in F2) measured in frame 2 and a CQI indicating channel quality between an MS (not shown) and the BS, and generates channel allocation information indicating the channel allocation result. Generally, channel quality between an RS and an MS is lower than channel quality between a BS and the RS, and, consequently, the BS may preferentially allocate channels of higher CQI's between the RS and the MS, to relay signals.

Next, the BS transmits the channel allocation information to the RS, and the RS receives the channel allocation information and relays the received channel allocation information, to the MS.

Thus, in a BS and RS, the frequency band to use for uplink signals and the frequency band to use for downlink signals are exchanged to each other, and the RS transmits an uplink signal to the BS using F2 temporarily. By this means, an MS can measure channel quality of F2 even in frame 2 in addition to in frame 1.

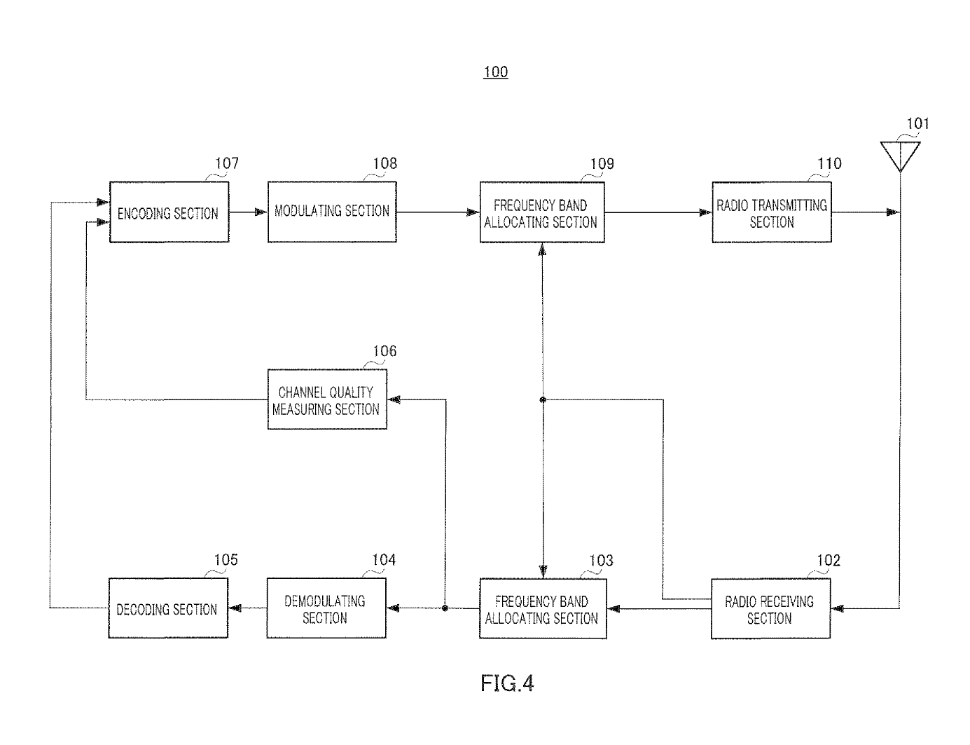

Next, the configuration of a relay station according to the present embodiment will be explained. FIG. 4 illustrates the configuration of relay station 100 according to the present embodiment.

In relay station 100, radio receiving section 102 receives an uplink signal from a mobile station, a downlink signal from a base station or a frequency band exchange command signal from the base station via antenna 101, and performs radio processing such as down-conversion, on these signals. Also, radio receiving section 102 outputs the uplink signal or downlink signal subjected to radio processing, to frequency band allocating section 103, and outputs the frequency band exchange command signal to frequency band allocating section 103 and frequency band allocating section 109.

If the frequency band exchange command signal is not received as input from radio receiving section 102, frequency band allocating section 103 allocates F1 to receive the uplink signal and allocates F2 to receive the downlink signal. By contrast, if the frequency band exchange command signal is received as input from radio receiving section 102, frequency band allocating section 103 allocates F1 to receive the downlink signal. Further, frequency band allocating section 103 outputs the uplink signal or the downlink signal to demodulating section 104 and channel quality measuring section 106.

Demodulating section 104 demodulates the uplink signal or the downlink signal received as input from frequency band allocating section 103, and outputs the demodulated signal to decoding section 105.

Decoding section 105 decodes the uplink signal or the downlink signal, and outputs the decoded data to encoding section 107.

Channel quality measuring section 106 measures channel quality of the uplink signal or the downlink signal received as input from frequency band allocating section 103, and generates a CQI corresponding to the measured channel quality. Further, channel quality measuring section 106 measures channel quality per frequency of the input signal. Further, channel quality measuring section 106 outputs the generated CQI to encoding section 107.

Encoding section 107 encodes the data received as input from decoding section 105 or the CQI received as input from channel quality measuring section 106, and outputs the encoded data or the encoded CQI to modulating section 108.

Modulating section 108 modulates the data or the CQI received as input from encoding section 107, and outputs the modulated signal to frequency band allocating section 109.

If a frequency band exchange command signal is not received as input from radio receiving section 102, frequency band allocating section 109 allocates F1 to transmit an uplink signal and allocates F2 to transmit a downlink signal. By contrast, if a frequency band exchange command signal is received as input from radio receiving section 102, frequency band allocating section 109 allocates F2 to transmit an uplink signal. That is, if a frequency band exchange command signal is received as input, frequency band allocating section 109 allocates F2, which is allocated to transmit a downlink signal, for the transmission of an uplink signal. Further, frequency band allocating section 109 outputs the modulated signal to radio transmitting section 110.

That is, according to frequency band exchange command signals, frequency band allocating section 109 temporarily allocates F2, which is allocated in frequency band allocating section 103 to receive downlink signals, for the transmission of uplink signals, while frequency band allocating section 103 temporarily allocates F1, which is allocated in frequency band allocating section 109 to transmit uplink signals, for the reception of downlink signals. Thus, in relay station 100, according to frequency band command signals, the frequency band used to transmit uplink signals and the frequency band used to receive downlink signals are exchanged to each other.

Radio transmitting section 110 performs radio processing such as up-conversion on the modulated signal, and relays the signal subjected to radio processing, from antenna 101 to the mobile station or the base station.

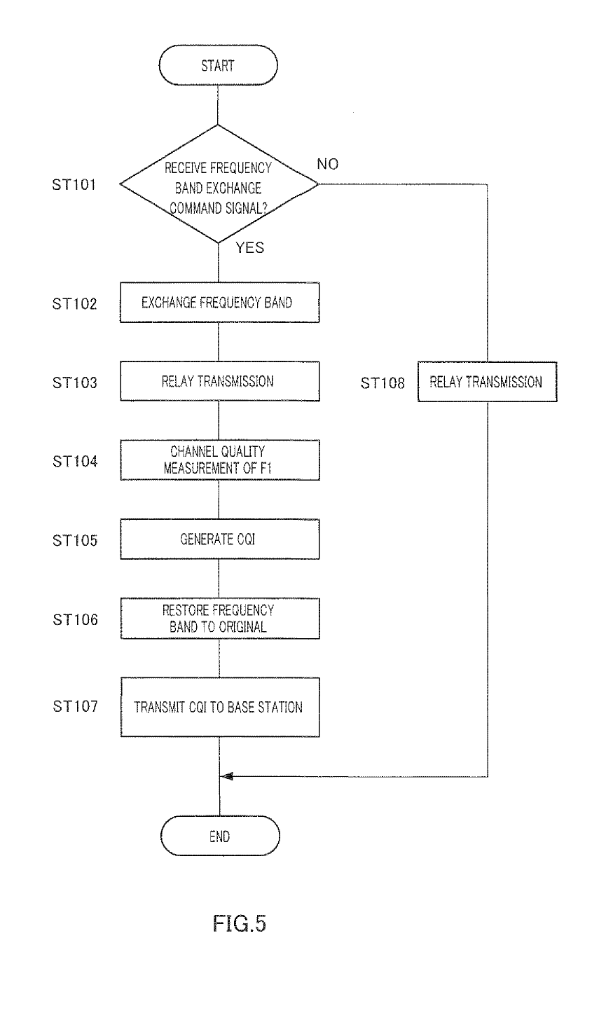

Next, the process flow in relay station 100 will be explained using the flowchart in FIG. 5.

If relay station 100 receives a frequency band exchange command signal in step (“ST”) 101 (“YES” in ST 101), in ST 102, relay station 100 exchanges between the frequency band used to transmit uplink signals and the frequency band used to receive downlink signals. That is, relay station 100 allocates F1, which is used to transmit uplink signals, for the reception of downlink signals, and allocates F2, which is allocated to receive downlink signals, for the transmission of uplink signals.

In ST 103, relay station 100 performs relay transmission using the exchanged frequency bands. That is, relay station 100 temporarily uses F1 to receive downlink signals, and temporarily uses F2 to transmit uplink signals. A mobile station can receive a signal using F2, so that, by temporarily using F2 in relay station 100 to transmit uplink signals, the mobile station measures channel quality in F2 not only in the ease of relay transmission of a downlink signal from relay station 100 to the mobile station, but also in the case of relay transmission of uplink signals from relay station 100 to a base station.

In ST 104, relay station 100 measures channel quality of the downlink signal received using F1 in ST 103.

In ST 105, relay station 100 generates a CQI based on channel quality measured in ST 104.

In ST 106, relay station 100 restores the frequency bands exchanged in ST 102 to the original. That is, relay station 100 allocates F1 to receive and transmit uplink signals and F2 to receive and transmit downlink signals.

In ST 107, relay station 100 transmits the CQI to the base station.

On the other hand, if relay station 100 does not receive a frequency band exchange command signal (“NO” in ST 101), relay station 100 performs relay transmission in ST 108. Here, relay station 100 relays uplink signals using F1 and relays downlink signals using F2.

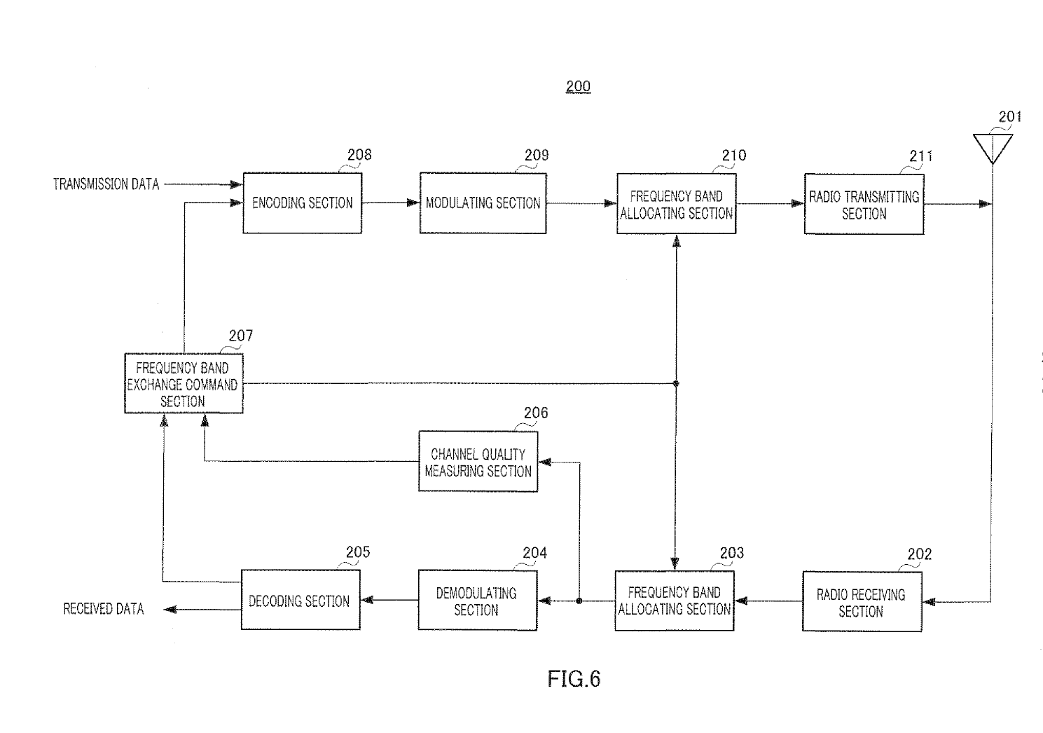

Next, the configuration of a base station according to the present embodiment will be explained. FIG. 6 illustrates the configuration of base station 200 according to the present embodiment.

In base station 200, radio receiving section 202 receives an uplink signal and CQI from a relay station, or an uplink signal without involving a relay station from a mobile station, via antenna 201, and performs radio processing such as down-conversion on the uplink signal or the CQI. Further, radio receiving section 202 outputs the uplink signal or CQI subjected to radio processing, to frequency band allocating section 203.

If a frequency band exchange command signal is not received as input from frequency band exchange command section 207, frequency band allocating section 203 allocates F1 to receive uplink signals. By contrast, if the frequency band exchange command signal is received as input from frequency band exchange command section 207, frequency band allocating section 203 allocates F2 to receive uplink signals. Further, frequency band allocating section 203 outputs the uplink signal to demodulating section 204 and channel quality measuring section 206, and outputs the CQI to demodulating section 204.

Demodulating section 204 demodulates the uplink signal and CQI, and outputs the demodulated uplink signal and CQI to decoding section 205.

Decoding section 205 decodes the uplink signal and CQI, and outputs the decoded CQI to frequency band exchange command section 207 and outputs the decoded uplink signal as received data.

Channel quality measuring section 206 measures channel quality of the uplink signal received as input from frequency band allocating section 203, and generates a CQI corresponding to the measured channel quality. That is, channel quality measuring section 206 measures channel quality between the relay station and the base station, and channel quality between the mobile station and the base station. Further, channel quality measuring section 206 outputs the generated CQI to frequency band exchange command section 207.

Frequency band exchange command section 207 decides whether or not to exchange between the frequency band used to receive uplink signals and the frequency band used to transmit downlink signals, based on the CQI received as input from channel quality measuring section 206 and the CQI received as input from decoding section 205. Further, if the frequency bands are exchanged, frequency band exchange command section 207 generates a frequency band exchange command signal indicating to exchange between F1 and F2. If the CQI's of channels allocated to transmission signals of base station 200, the mobile station and relay station 100 are less than a threshold, and if frequency band exchange command section 207 decides that another channel of a higher CQI needs to be allocated, frequency band exchange command section 207 generates a frequency band exchange command signal. Here, to always select optimal channels among the channels allocated to transmission signals of base station 200, the mobile station or relay station 100, frequency band exchange command section 207 may generate frequency band exchange command signals at certain time intervals. Further, frequency band exchange command section 207 outputs the frequency band exchange command signal to encoding section 208.

Encoding section encodes transmission data and the frequency band exchange command signal received as input from frequency command exchange command section 207, and outputs the encoded data and encoded frequency band exchange command signal to modulating section 209.

Modulating section 209 modulates the data and frequency band exchange command signal received as input from encoding section 208, and outputs the modulated signal to frequency band allocating section 210.

If the frequency band exchange command signal is not received as input from frequency band exchange command section 207, frequency band allocating section 210 allocates F2 to transmit the modulated signal, that is, to transmit a downlink signal. By contrast, if the frequency band exchange command signal is received as input from frequency band exchange command section 207, frequency band allocating section 210 allocates F1 to transmit downlink signals. Further, frequency band allocating section 210 outputs the modulated signal to radio transmitting section 211.

That is, according to frequency band exchange command signals, frequency band allocating section 210 temporarily allocates F1, which is allocated in frequency band allocating section 203 to receive uplink signals, for the transmission of downlink signals, while frequency band allocating section 203 temporarily allocates F2, which is allocated in frequency band allocating section 210 to transmit downlink signals, for the reception of uplink signals. Thus, in base station 200, according to frequency band command signals, the frequency band used to receive uplink signals and the frequency band used to transmit downlink signals are exchanged to each other.

Radio transmitting section 211 performs radio processing such as up-conversion on the modulated signal, and transmits the signal subjected to radio processing to relay station 100 from antenna 201.

Thus, according to the present embodiment, upon receiving a frequency band exchange command signal, a relay station temporarily uses the frequency band used to transmit downlink signals, for the transmission of uplink signals. Accordingly, a mobile station can receive signals from the relay station using many channels. By this means, the mobile station can measure channel quality in a wider band. Therefore, according to the present embodiment, it is possible to improve the accuracy of channel quality measurement at a mobile station between a relay station and a mobile station.

Also, according to the present embodiment, upon receiving a frequency band exchange command signal, a relay station temporarily uses the frequency band used to transmit uplink signals, for the reception of downlink signals, so that it is possible to receive a downlink signal transmitted from a base station, regardless of whether or not the downlink signal is addressed to that relay station. Therefore, the relay station can measure channel quality between the relay station and the base station by using many channels in the frequency band used to transmit uplink signals, so that it is possible to improve the accuracy of channel quality measurement at the relay station between the base station and the relay station.

Also, according to the present embodiment, a mobile station receives uplink signals transmitted from a relay station and measures channel quality, so that efficient channel quality measurement is possible in more channels than in the case of channel quality measurement only of downlink signals. Therefore, as a result of applying a relay transmission technique to mobile communication, even if the number of channels to require channel quality measurement increases, it is possible to perform relay transmission efficiently without increasing pilot signals for channel quality measurement.

### Embodiment 2

The present embodiment differs from Embodiment 1 in, when a relay station transmits an uplink signal using F2, reporting allocation information indicating the MCS (Modulation and Coding Scheme) level of the uplink signal and the channel used to transmit the uplink signal among a plurality of channels included in F2, to a mobile station.

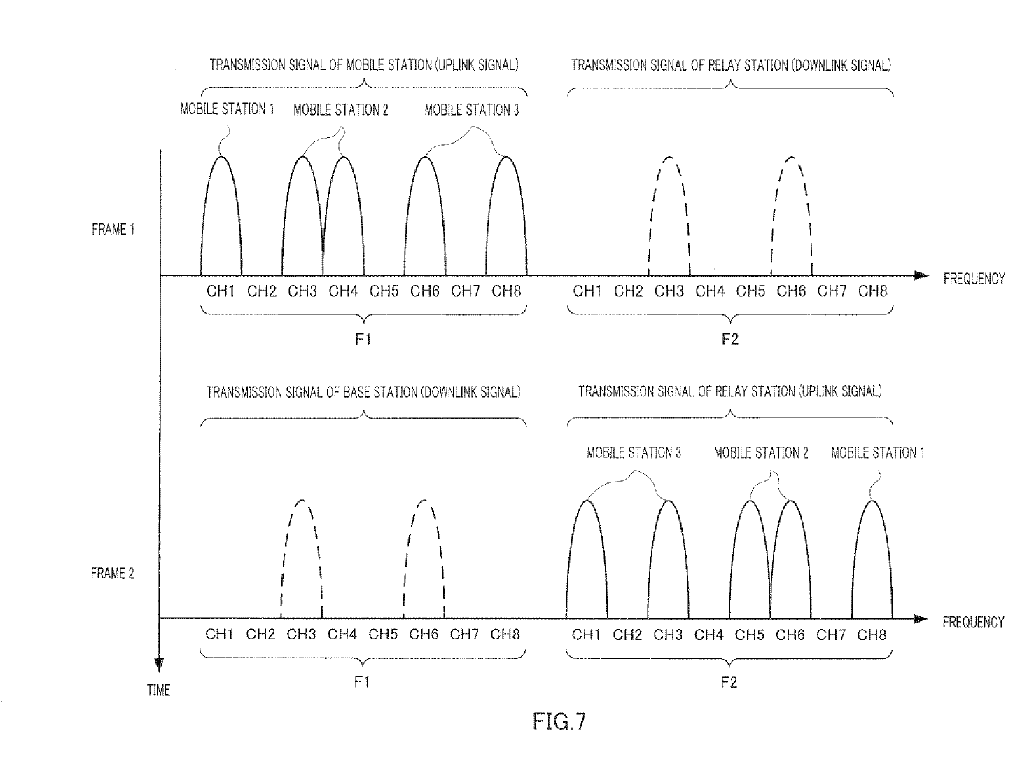

FIG. 7 illustrates a frequency band allocation according to the present embodiment. Here, F1 and F2 are each formed with CH's 1 to 8.

First, in frame 1, each mobile station transmits an uplink signal using F1. To be more specific, as shown in FIG. 7, mobile station 1 transmits an uplink signal using CH1 in F1, mobile station 2 transmits uplink signals using CH 3 and CH 4 in F1, and mobile station 3 transmits uplink signals using CH 6 and CH 8 in F1. Also, in frame 1, as shown in FIG. 7, a relay station transmits downlink signals using CH 3 and CH 6 in F2.

Here, if a base station transmits a frequency band exchange command signal to the relay station, the frequency band used for uplink signals and the frequency band used for downlink signals are exchanged between frame 1 and frame 2. Therefore, in frame 2, the relay station temporarily uses F2 to transmit uplink signals. To be more specific, as shown in FIG. 7, in frame 2, the relay station transmits an uplink signal from mobile station 1 using CH 8 in F2, transmits uplink signals from mobile station 2 using CH 5 and CH 6 in F2 and transmits uplink signals from mobile station 3 using CH1 and CH 3 in F2. Also, in frame 2, as shown in FIG. 7, the base station transmits downlink signals using CH 3 and CH 6 in F1.

Further, in frame 2, the relay station reports allocation information indicating the MCS level and channel that are used for the relay transmission of an uplink signal from each mobile station, to mobile stations 1 to 3. By this means, a mobile station, to which allocation information is reported, can identify in which MCS level an uplink signal transmitted by that mobile station is relayed and by which channel in F2 the uplink signal is relayed. Here, the relay station may determine the channel to use for the transmission of allocation information according to channel allocation information transmitted from the base station, and determine the channel from the channels allocated to the relay station.

Therefore, in frame 2, each mobile station receives an uplink signal transmitted from the relay station using F2 and receives allocation information. Further, with the allocation information, each mobile station can identify to which channel in F2 an uplink signal from that mobile station is allocated and in which MCS level the uplink signal is relayed, so that it is possible to measure channel quality using data signals in addition to pilot signals. For example, mobile station 1 can identify the uplink signal from that mobile station, allocated to CH 8 in F2 of frame 2. Therefore, mobile station 1 can measure channel quality using a pilot signal and data signal in CH 8 in F2. On the other hand, in the remaining CH 1, CH 3, CH 5 and CH 6 other than CH 8 in F2, uplink signals from other mobile stations than mobile station 1 are allocated, and, consequently, mobile station 1 cannot identify the data signals allocated to CH 1, CH 3, CH 5 and CH 6. Therefore, mobile station 1 measures channel quality using only pilot signals in CH 1, CH 3, CH 5 and CH 6. The same applies to mobile station 2 and mobile station 3.

Thus, by reporting allocation information from a relay station to mobile stations, the mobile stations can measure channel quality using pilot signals and data signals, so that more accurate channel quality measurement is possible.

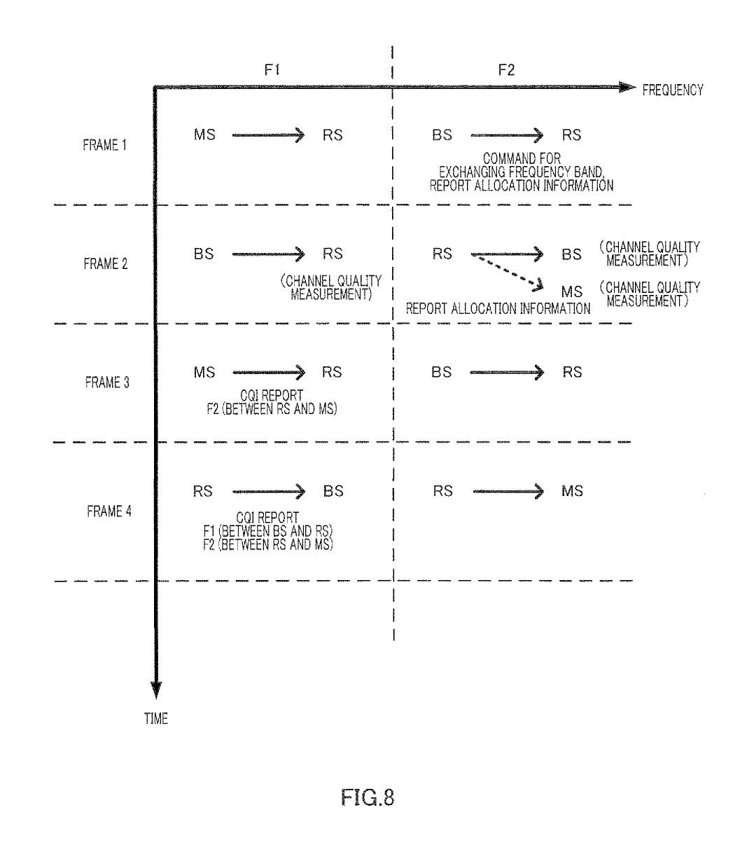

Next, FIG. 8 illustrates a sequence diagram of the mobile communication system according to the present embodiment. In FIG. 8, a relay station (“RS”) performs relay transmission between a base station (“BS”) and a mobile station (“MS”). In this case, there is also an MS (not shown) that performs direct communication with a BS without involving an RS, and the BS measures channel quality between the BS and the MS. Here, for ease of explanation, explanation of an MS that performs direct communication with a BS without involving an RS, will be omitted. Also, explanation will be omitted for the same operations as in the sequence diagram shown in FIG. 3 of Embodiment 1.

As shown in FIG. 8, in F2 of frame 1, a BS transmits a frequency band exchange command signal and allocation information to an RS. Therefore, in the BS and the RS, when the target frame shifts from frame 1 to frame 2, the frequency band used for uplink signals and the frequency band used for downlink signals are temporarily exchanged between F1 and F2.

Further, in F2 of frame 2, the RS transmits the uplink signal and allocation information received in frame 1, to the BS, using the MCS level and channels in F2 indicated by the allocation information. The BS then measures channel quality between the BS and the RS, using the uplink signal received in F2. Also, an MS receives the uplink signal and allocation information in F2 of frame 2, and measures the received quality between the RS and the MS. Here, an MS can specify the uplink signal transmitted from that MS in frame 1, based on the MCS level and channel of F2 indicated by the allocation information, thus measuring channel quality using pilot signals and data signals relayed from the RS to the BS.

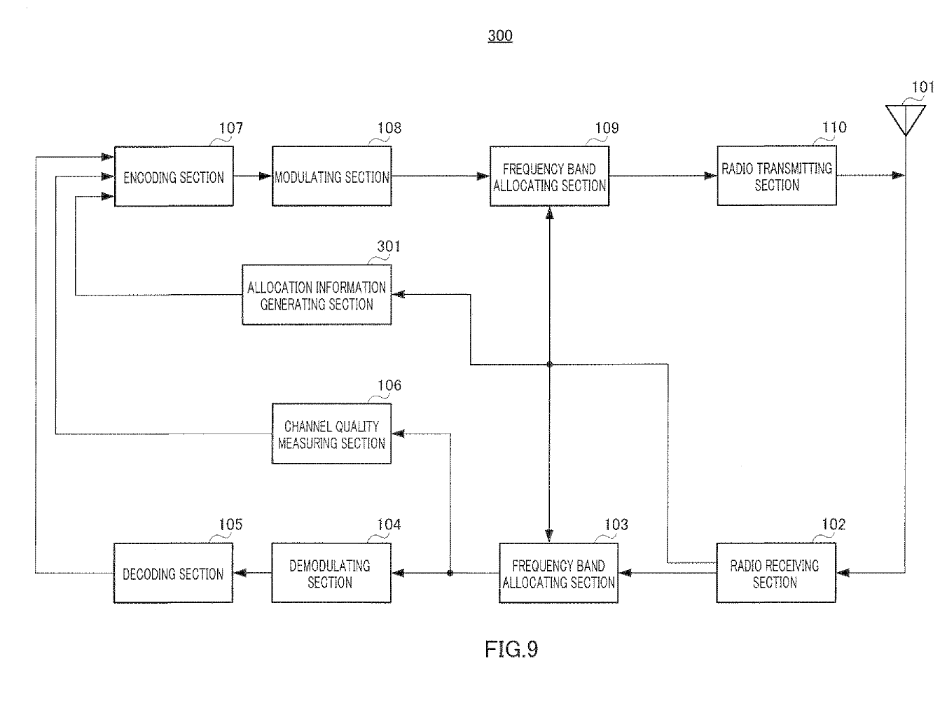

Next, FIG. 9 illustrates the configuration of relay station 300 according to the present embodiment. In FIG. 9, the same components as in Embodiment 1 (FIG. 4) will be assigned the same reference numerals and explanation will be omitted.

If a frequency band exchange command signal is received as input from radio receiving section 102, allocation information generating section 301 generates the above allocation information. Allocation information generating section 301 then outputs the generated allocation information to encoding section 107.

Radio transmitting section 110 transmits allocation information to a mobile station via antenna 101.

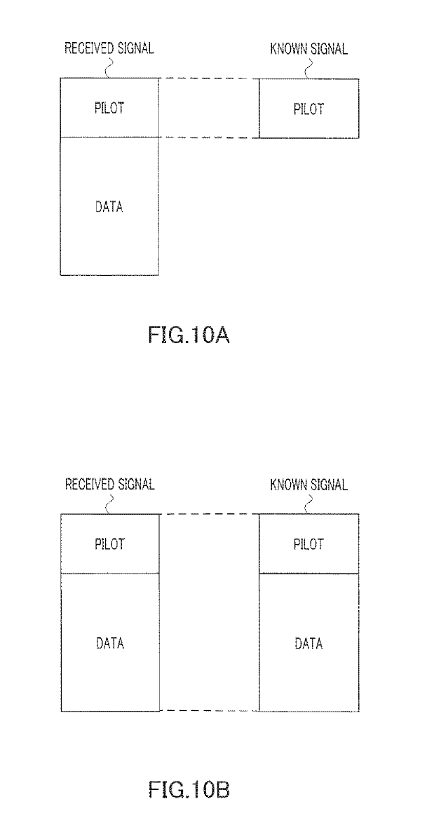

Here, a case where channel quality is measured using only a pilot signal (FIG. 10A) is compared to a case where channel quality is measured using a pilot signal and data signal (FIG. 10B). Channel quality is measured by finding the variation between channels, from the difference between a received signal and a known signal. In this case, a received signal includes noise that is added upon reception. It is possible to measure channel quality based on the average value of signals, using more signals when a pilot signal and data signal are known as shown in FIG. 10B than when only a pilot signal is known as shown in FIG. 10A, so that it is possible to provide a better noise averaging effect. Therefore, it is possible to improve the accuracy of channel quality measurement in the case of FIG. 10B.

Thus, according to the present embodiment, a mobile station can measure channel quality using data signals of that mobile station in addition to pilot signals, so that it is possible to further improve the accuracy of channel quality measurement, compared to Embodiment 1.

Also, with the present embodiment, as shown in FIG. 7, the channel placement for uplink signals in F1 of frame 1 and the channel placement for uplink signals in F2 of frame 2 need not be the same. Also, if there is a channel especially requiring channel quality measurement among a plurality of channels between a relay station and a mobile station, the relay station may allocate an uplink signal to that channel requiring channel quality measurement in frame 2. By this means, the mobile station can measure only the required channel quality efficiently.

### Embodiment 3

A case will be explained with the present embodiment where a base station performs precoding.

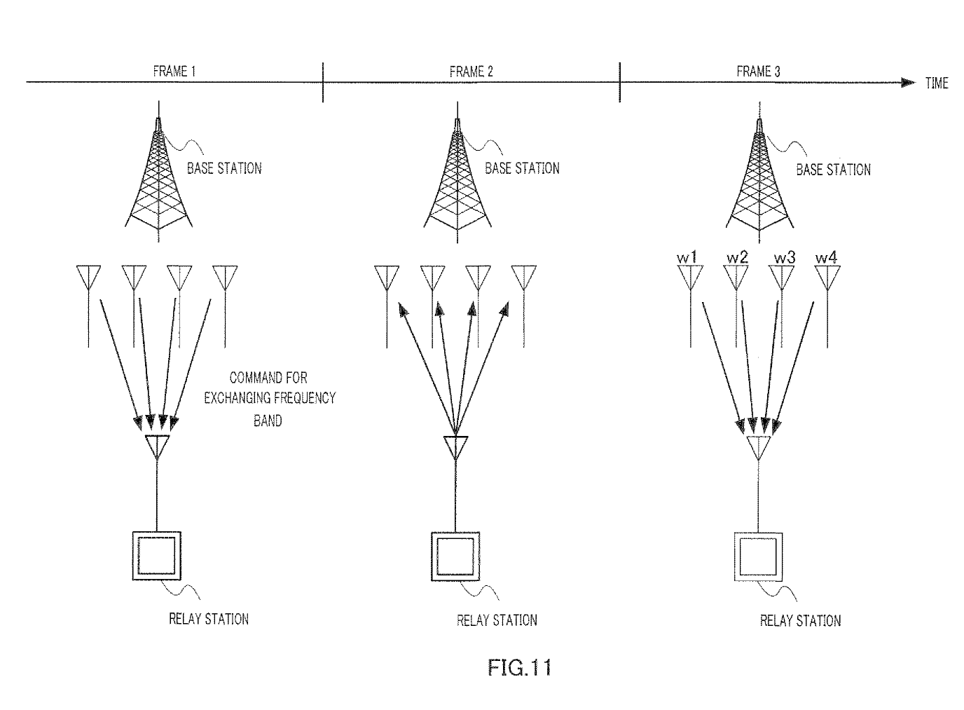

FIG. 11 illustrates the configuration of the mobile communication system according to the present embodiment. Here, a base station has four antennas.

When a base station performs precoding on a per antenna basis, channel quality between that base station and a relay station needs to be measured on a per antenna basis. That is, channel quality in F2 between a base station and a relay station needs to be measured on a per antenna basis.

Therefore, with the present embodiment, when a base station having four antennas performs precoding on a per antenna basis, the frequency band used for uplink signals and the frequency band used for downlink signals are exchanged to each other. That is, a relay station transmits uplink signals using F2 temporarily. By this means, a base station can measure channel quality between the base station and a relay station on a per antenna basis, using uplink signals transmitted from that relay station using F2.

This will be explained below in detail using FIG. 11.

As shown in FIG. 11, a relay station having received a frequency band exchange command signal in frame 1 transmits uplink signals to a base station, using F2 temporarily in frame 2.

In frame 2, the base station receives the uplink signals from the relay station using four antennas. The base station then measure channel quality on a per antenna basis using an uplink signal received by each antenna, and generates weights w1 to w4 for precoding based on the measured channel quality.

In frame 3, as shown in FIG. 11, the base station multiplies downlink signals by weights w1 to w4 corresponding to those antennas, respectively, and transmits the downlink signals multiplied by the weights from the four antennas to the relay station, using F2. Therefore, the relay station receives the downlink signals subjected to precoding by weights generated based on uplink signals, using F2 in frame 3.

Thus, the weights by which downlink signals transmitted from the antennas of a base station are multiplied, are generated based on a relayed signal from a relay station. As in Embodiment 1, a base station receives a relay signal grouping uplink signals from a plurality of mobile stations, using F2, so that it is possible to measure channel quality in a wide band and improve the accuracy of channel quality measurement. Therefore, it is possible to improve received quality at a relay station for a downlink signal subjected to precoding, using weights w1 to w4 generated based on a relay signal from the relay station.

Also, a base station can receive uplink signals from a relay station on a per antenna basis, so that the base station needs not transmit pilot signals that are orthogonal between antennas, to the relay station in order to acquire CQI's on a per antenna basis.

Also, a base station may multiply a pilot signal by a weight for precoding. For example, a relay station receives a pilot signal subjected to precoding in frame 3 shown in FIG. 11, and thereupon acquires information about the weight for the data signal from the pilot signal multiplied by a weight.

Further, the relay station acknowledges that a downlink signal subjected to precoding is received in the next frame (frame 3) to the frame (frame 2) in which an uplink signal is transmitting using F2. Therefore, even if the base station does not report to the relay station that the base station transmits a downlink signal subjected to precoding, the relay station can identify the timing at which the downlink signal subjected to precoding is received, based on the timing of transmitting an uplink signal using F2 temporarily.

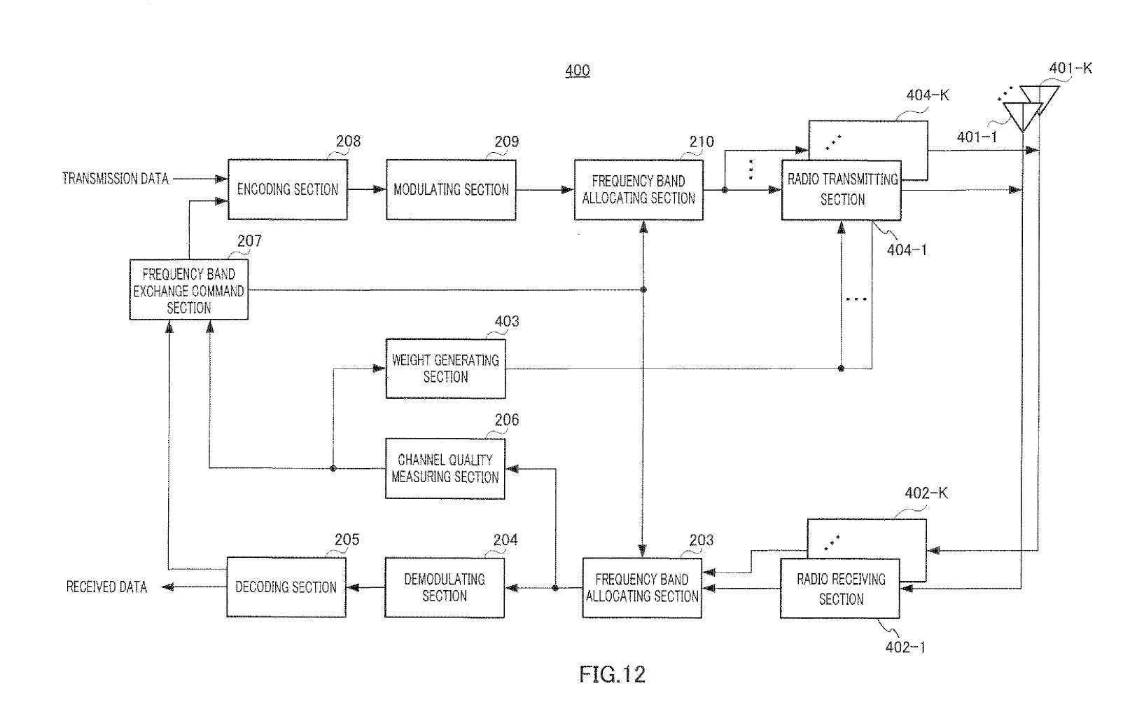

Next, FIG. 12 illustrates the configuration of base station 400 according to the present embodiment. In FIG. 12, the same components as in Embodiment 1 (FIG. 6) will be assigned the same reference numerals and explanation will be omitted.

Radio receiving sections 402-1 to 402-K are provided in association with antennas 401-1 to 401-K. Radio receiving sections 402-1 to 402-K receive uplink signals from a relay station via antennas 401-1 to 401-K.

Channel quality measuring section 206 measures channel quality of K uplink signals received as input from frequency band allocating section 203, and generates CQI's corresponding to the measured channel quality. That is, channel quality measuring section 206 generates a CQI for each of antennas 401-1 to 401-K. Channel quality measuring section 206 generates control information including K CQI's generated, and outputs it to frequency band exchange command section 207 and weight generating section 403.

Weight generating section 403 generates weights w1 to wK for precoding corresponding to antennas 401-1 to 401-K, respectively, based on the CQI's included in the control information received as input from channel quality measuring section 206. For example, weight generating section 403 generates weights that make transmission signals orthogonal between antennas, as in eigenmode transmission. Further, weight generating section 403 outputs the generated weights w1 to wK for each antenna, to radio transmitting sections 404-1 to 404-K.

Frequency band exchange command section 207 generates a frequency band exchange command signal such that the above frequency band exchanging is performed in an earlier frame than the frame in which precoding of transmission signals is performed. For example, if precoding of transmission signals is performed in frame 3 shown in FIG. 11, frequency band exchange command section 207 generates a frequency band exchange command signal in frame 1.

Radio transmitting sections 404-1 to 404-K are provided in association with antennas 401-1 to 401-K. Radio transmitting sections 404-1 to 404-K multiply transmission signals received as input from frequency band allocating section 210 by weights received as input from weight generating section 403, and transmit the signals multiplied by the weights to the relay station via antennas 401-1 to 401-K.

Also, when the relay station receives a frequency band exchange command signal in frame 1 shown in FIG. 11, in frame 2, the relay station transmits uplink signals to the base station temporarily using the channels in F2 allocated based on channel allocation information. Also, the base station uses the channels in F2, to which the uplink signals received in F2 of frame 2 shown in FIG. 11 are allocated, to transmit downlink signals subject to precoding in frame 3. Also, in frame 3 shown in FIG. 11, the relay station receives the downlink signals subjected to precoding using the channels used to transmit uplink signals in frame 2.

That is, the relay station uses the channels used to transmit downlink signals in frame 2, for the reception of the downlink signals subjected to precoding, in frame 3. By this means, even if the base station does not report channel allocation information, the relay station can identify the channels to which the downlink signals subjected to precoding are allocated, so that it is possible to reduce the channel allocation information from the base station.

Thus, according to the present embodiment, a base station measure channel quality based on uplink signals transmitted from a relay station, so that, even when precoding is performed, it is possible to generate weights based on channel quality of high measurement accuracy.

Also, according to the present embodiment, a base station receives uplink signals from a relay station by a plurality of antennas and measures channel quality on a per antenna basis, so that it is not necessary to transmit pilot signals that are orthogonal between antennas from the base station to the relay station or report CQI'S from the relay station to the base station. Therefore, according to the present embodiment, it is possible to reduce the amount of information and the amount of processing required to generate weights.

### Embodiment 4

With the present embodiment, relay stations specify a base station using identifiers that are assigned to the same base station and that vary between a plurality of relay stations.

A base station according to the present embodiment reports, to relay stations, serving relay station information indicating the associations between relay stations and the mobile stations in which the relay stations manage relay transmission. Based on the serving relay station information, the relay stations identify the mobile stations in which those relay stations manage relay transmission, and relay the serving relay station information to these mobile stations. Based on the serving relay station information, the mobile stations identify the relay stations that manage those mobile stations, identify other mobile stations managed by those relay stations, receive pilot signals transmitted to those other mobile stations and measure channel quality.

Also, the base station reports, to relay stations and mobile stations, channel allocation information indicating the associations between the channels of F2 and the destination apparatuses of the signals allocated to the channels. Based on the serving relay station information and channel allocation information, the relay stations and mobile stations then specify the transmission source apparatus and destination apparatus of the signal allocated to each channel. For example, if the destination apparatus indicated by channel allocation information is a mobile station, relay stations and mobile stations can specify the relay station that manages the destination mobile station, among the relay stations indicated by serving relay station information, as the transmission source apparatus. Also, if the destination apparatus indicated by channel allocation information is a relay station, relay stations and mobile stations can specify the base station as the transmission source apparatus.

However, if the frequency band used for uplink signals and the frequency band used for downlink signals are temporarily exchanged in a base station and relay stations, there is a possibility that the destination apparatus indicated by channel allocation information results in the base station. As a result, in this case, it may not be able to specify which relay station is the transmission source apparatus for signals addressed to the base station. Therefore, each relay station cannot transmit a signal. Also, mobile stations cannot specify whether or not the serving relay station of those mobile stations transmits signals addressed to the base station, and, consequently, the mobile stations cannot measure channel quality.

Therefore, relay stations specify a base station using identifiers that are allocated to the same base station and that vary between a plurality of relay stations. Also, the relay stations specify the base station using identifiers that can identify the base station as a virtual mobile station. By this means, even if the frequency band used for uplink signals and the frequency band used for downlink signals are exchanged temporarily in a base station and relay stations, the relay stations can specify the base station without changing the format of serving relay station information and channel allocation information.

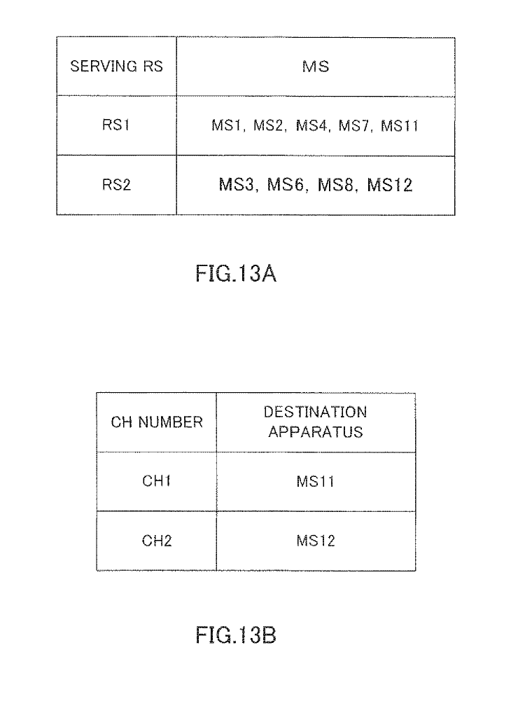

This will be explained below in detail. FIG. 13A illustrates serving relay station information. To be more specific, as shown in FIG. 13A, relay station (“RS”) 1 manages relay transmission for mobile station (“MS”) 1, MS 2, MS 4, MS 7 and MS 11, and RS 2 manages relay transmission for MS 3, MS 6, MS 8 and MS 12. Here, by serving relay station information, a single BS is managed as virtual mobile station MS 11 for RS 1 and as virtual mobile station MS 12 for RS 2. That is, MS 11 and MS 12 shown in FIG. 13A represent the same BS.

Next, FIG. 13B illustrates channel allocation information for F2. To be more specific, as shown in FIG. 13B, a signal addressed to MS 11 is allocated to CH 1 of F2 and a signal addressed to MS 12 is allocated to CH 2 of F2. Here, as shown in FIG. 13A, the relay station that manages MS 11 is RS 1. Therefore, it is possible to specify the transmission source apparatus of the signal allocated to CH 1, as RS 1. Similarly, as shown in FIG. 13A, the relay station that manages MS 12 is RS 2. Therefore, it is possible to specify the transmission source apparatus of the signal allocated to CH 2, as RS 2.

Also, as shown in FIG. 13A, by managing a base station as a virtual mobile station by serving relay station information, a mobile station can identify a signal from the relay station to the base station as a signal to another mobile station that is managed by the serving relay station for that mobile station, so that channel quality measurement is possible.

Thus, according to the present embodiment, a single base station is specified using identifiers that vary between relay stations. By this means, even if the frequency band used for uplink signals and the frequency band used for downlink signals are exchanged in a base station and a relay station, a mobile station can measure channel quality reliably.

Also, frequency band allocating section 109 of relay station 100 shown in FIG. 4 and frequency band allocating section 109 of relay station 400 shown in FIG. 9 may hold the serving relay station information and channel allocation information described with the present embodiment, and specify a base station using the above identifiers that vary between relay stations.

Embodiments of the present invention have been explained above.

Also, channel quality measurement according to the above embodiments can be performed by measuring the SNR, the SIR, the SINR, the CIR, the CNR, the CINR, the RSSI, the receiving power, the interference power, the error rate, the transmission rate, throughput, the prediction error rate, the moving speed of a mobile station, the magnitude of channel variation, and so on. Also, it is equally possible to measure channel quality based on the type of the error correcting code.

Also, with the above embodiments, when frequency bands are exchanged, a mobile station may transmit an uplink signal to a relay station in F1 and receive a downlink signal from a base station in F2. In this case, the base station needs to separate transmission signals from reception signals in F1 and F2.

Also, with the above embodiments, a plurality of subcarriers are used as a plurality of channels. Here, a channel is not necessarily a subcarrier. A channel needs to be a transmission unit that can be classified by time, frequencies, codes, antennas, streams, and so on.

Also, with the present invention, frequency bands may be exchanged only when the number of channels used in a relay station to perform relay transmission to a base station is over a threshold. This number of channels is equal to the number of CQI's that are received as input in frequency band exchange command section 207 shown in FIG. 6 and FIG. 12, so that it is possible to determine that number of channels from the number of CQI's that are received as input in frequency band exchange command section 207 shown in FIG. 6 and FIG. 12. If the number of channels used in a relay station is small, the number of channels that can be received in a mobile station is also small, and the accuracy of channel quality measurement does not improve much. By contrast with this, if the number of channels used in a relay station is large, the number of channels that can be received in a mobile station is also large, and the mobile station can measure channel quality in a wider band, so that it is possible to improve the accuracy of channel quality measurement significantly.

Also, frames 1, 2 and 3 in the above embodiments need not be always consecutive. That is, the essential requirement is that frame 2 is positioned after frame 1 and frame 3 is positioned after frame 2.

Also, with the above embodiments, exchanged frequency bands are restored to the original one frame later. However, with the present invention, the timing of restoring exchanged frequency bands to the original is not limited to one frame later, but may be predetermined frames later. Also, a base station may transmit a command signal that commands exchanged frequency bands to be restored to the original, to a relay station, and the relay station may restore the exchanged frequency band to the original bands based on the command signal.

Also, with the above embodiments, there may be additional relay stations between a relay station and a base station or between a mobile station and a relay station. Also, a base station may receive signals from mobile stations via a plurality of relay stations.

Also, a base station and mobile station may be referred to as “node B” and “UE,” respectively. Also, a relay station may be referred to as a “repeater,” “simple base station,” “cluster head,” and so on. Also, a subcarrier may be referred to as a “tone.”

Although a case has been described above with the above embodiments as an example where the present invention is implemented with hardware, the present invention can be implemented with software.

Furthermore, each function block employed in the description of each of the aforementioned embodiments may typically be implemented as an LSI constituted by an integrated circuit. These may be individual chips or partially or totally contained on a single chip. “LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of an FPGA (Field Programmable Gate Array) or a reconfigurable processor where connections and settings of circuit cells in an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2007-135578, filed on May 22, 2007, including the specification, drawings and abstract, is incorporated herein by reference in its entirety.

### INDUSTRIAL APPLICABILITY

The present invention is applicable to communication systems in which radio communication apparatuses such as mobile stations and base stations perform radio communication via relay stations (e.g. multi-hop system).

1. A mobile communication system comprising a radio communication base station apparatus, a radio communication mobile station apparatus and a radio communication relay station apparatus that performs relay transmission between the radio communication base station apparatus and the radio communication mobile station apparatus, wherein:
using a first frequency band, the radio communication relay station apparatus transmits a downlink signal in a first frame and transmits an uplink signal in a second frame; and
using the first frequency band, the radio communication mobile station apparatus receives the downlink signal in the first frame and receives the uplink signal in the second frame.

2. A radio communication relay station apparatus that performs relay transmission between a radio communication base station apparatus and a radio communication mobile station apparatus, comprising:
an allocating section that allocates a first frequency band to transmit a downlink signal in a first frame and to transmit an uplink signal in a second frame; and
a transmitting section that, using the first frequency band, transmits the downlink signal in the first frame and transmits the uplink signal in the second frame.

3. The radio communication relay station apparatus according to claim 2, wherein the allocating section allocates a second frequency band to transmit the uplink signal in the first frame and to receive the downlink signal in the second frame.

4. The radio communication relay station apparatus according to claim 2, further comprising a generating section that generates allocation information indicating a modulation and coding scheme level of the uplink signal and a channel to use to transmit the uplink signal among a plurality of channels included in the first frequency band,
wherein the transmitting section transmits the allocation information in the second frame.

5. The radio communication relay station apparatus according to claim 2, further comprising a receiving section that, using the first frequency band in a third frame, receives the downlink signal subjected to precoding by a weight generated based on the uplink signal.

6. The radio communication relay station apparatus according to claim 5, wherein, using the first frequency band in the third frame, the receiving section receives a pilot signal subjected to precoding by the weight.

7. The radio communication relay station apparatus according to claim 2, further comprising a specifying section that specifies the radio communication base station apparatus, using identifiers that are allocated to a same radio communication base station apparatus and that vary between a plurality of radio communication relay station apparatuses.

8. The radio communication relay station apparatus according to claim 7, wherein the specifying section specifies the radio communication base station apparatus, using the identifiers that can identify the radio communication base station apparatus as a virtual radio communication mobile station apparatus.

9. A relay transmitting method in a radio communication relay station apparatus that performs relay communication between a radio communication base station apparatus and a radio communication mobile station apparatus, the method comprising, using a first frequency band, transmitting a downlink signal in a first frame and transmitting an uplink signal in a second frame.
